(19) United States
(12) Patent Application Publication
(10) Pub. No.: US 2006/0089839 A1
(43) Pub. Date: Apr. 27, 2006

(54) Enhanced customer design visual integration (ECDVI)

(76) Inventor: Donna Silver Smiley, Montclair, VA (US)

Correspondence Address: Donna Smiley, 16211 S. Edgewood Dr., Montclair, VA, 22026, US

(21) Appl. No.: 10/968,881

(22) Filed: Oct. 21, 2004

(51) Int. Cl. G06Q 99/00

(52) U.S. Cl. 705/1

(57) ABSTRACT

An Enhanced Customer Design Visual Integration (ECDVI) utilizing a Web based application to support Interior and Exterior Painting, Decorating, Landscaping, and other design integration efforts. This solution will provide customer with the capability to take a digital picture of a setting and integrate it into a future concept or solution for a true final conclusion. This integration setting will support 3-D technology and XML approaches for a common resolution. ECDVI provides customers with a true picture of a project; therefore giving them the ability to make immediate decisions (saving time and money), without having to physically test and undertake every possible solution. The customer, should they choose to, would never have to leave their home to meet there require needs.

### BACKGROUND

When a consumer has the desire or need to purchase furniture or fixtures for their homes or make cosmetic changes to the inside or outside of a structure, they want to make sure that they are completely satisfied with the final design efforts. It is necessary to shop around to consider more that one possible solution or choice. A true picture of the final outcome is difficult to visualize from sheer memory of the setting and it surroundings. Numerous visits with several vendors may be necessary or products that are purchased may need to be exchanged or returned. This can be time consuming and costly. With today's technological advances, this process can be simplified and made much easier. ECDVI eliminates the guesswork and legwork of redesigning a home, office or any other chosen space or structure.

### SUMMARY

According to an embodiment, the present invention may provide an innovative and easy solution for interior designers, paint stores, furniture and accessories retailers and manufacturers, and consumers.

### DETAILED DESCRIPTION

Embodiments of the present invention provides an enhanced customer design process. This process will digitally integrate customer environment (i.e. homes, offices, design efforts) to provide a synchronized presentation of customers environment and manufacturer, retailer or furniture retailer desires. This time saving invention harmonizes customer's design with 3-D technology and current digital presentation software. The customer will have the capability of viewing the enhanced 3D image of their actual room or structure and get a true view of the finished product/room. This will allow for quicker decision making. The 3-D images can be exchanged, as often as needed, between the customer and provider, to allow for changes that is desired by the customer, until the customer is satisfied with the solution. The customer will also have the ability to utilize on-line catalogs to create their own 3-D image and make necessary changes.

### BRIEF DESCRIPTION OF THE DRAWING

FIG. 1 is a block diagram of ECDVI providing enhanced communication, via the Internet, between the customer and various service/product providers.

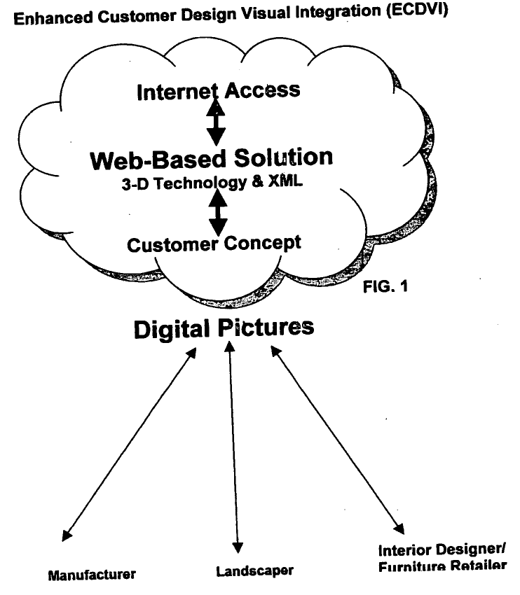

I claim:

1. The customer will take a digital photo of a setting, room, or structure and send it electronically to a service or product provider (i.e. Paint dealer, furniture retailer or manufacturer, accessories retailer, landscaper, interior designer etc.).

2. The service or product provider will open the digital image and integrate into it, various solutions or design options in a 3-D setting.

3. The enhanced images of the initial setting can be returned electronically to the customer for viewing and selection or decision-making.
